(19) United States
(12) Patent Application Publication
(10) Pub. No.: US 2010/0221049 A1
(43) Pub. Date: Sep. 2, 2010

(54) CLEANSING APPARATUS AND IMAGE FORMING APPARATUS HAVING THE SAME

(76) Inventor: Gotoda Katsuhiko, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 12/695,123

(22) Filed: Jan. 27, 2010

(30) Foreign Application Priority Data
Mar. 2, 2009 (TW) 098106680

(51) Int. Cl. G03G 21/00

(52) U.S. Cl. 399/350; 399/358

(57) ABSTRACT

A cleansing apparatus includes a blade, a gathering tank and a residual material transportation module for cleansing a photoconductor drum. The blade contacts the photoconductor drum, and scrapes off residual materials adhered to a surface of the photoconductor drum. The gathering tank gathers the residual materials. The residual material transportation module includes a transportation component, a cleansing component, and a path, for cleansing the photoconductor drum and transporting the residual materials to the gathering tank. The transportation component is disposed at an upstream position towards the blade on a rotating direction of the photoconductor drum. The cleansing component is disposed on the transportation component and in contact with the photoconductor drum, for cleansing the photoconductor drum. The path is formed by the transportation component and the cleansing component. The residual material transportation module transports residual materials of the photoconductor drum to the gathering tank through the path.

### BACKGROUND OF THE INVENTION

1. Field of the Invention

The present invention relates to a cleansing apparatus of an image forming apparatus, and more particularly, to a cleansing apparatus for cleansing a photoconductor drum of a laser printer, wherein the cleansing apparatus employs a single driving apparatus to simultaneously drive a cleansing component (functioning as a brush) and a residual material transportation component.

2. Description of the Prior Art

There are seven main steps in the image forming process of a laser printer: charging, exposure, developing, transferring, fusing, cleansing and erasing. The laser printer utilizes an apparatus composed of a photoconductor drum to perform the image forming process, and is the most essential part in the laser printer. When the photoconductor drum operates, toners for forming images are transferred onto a recording medium (e.g. paper). However, a portion of toners cannot be successfully transferred onto the recording medium and are adhered to the surface of the photoconductor drum. Moreover, the impurities carried by the recording medium (e.g. paper scraps or calcium carbonate generated in the paper fabrication) or other dusts could contact the photoconductor drum, and be adhered to the photoconductor drum due to air convection, or during the developing step.

Therefore, the cleansing step is employed for solving this problem to prevent the impurities and toners from affecting the image forming quality. Please refer to FIG. 1, which illustrates a diagram of a conventional cleansing apparatus. As shown in FIG. 1, a cleansing apparatus 110 is employed for removing the impurities and toners adhered to a photoconductor drum 100, wherein the cleansing apparatus 110 includes a blade 112, a brush 114, and a toner transportation component 116. When the photoconductor drum 100 rotates in a direction R, the brush 114 will rotate in a same or a reverse direction as the direction R to brush away a portion of the toners and impurities on the photoconductor drum 100. A gathering apparatus (not shown) is further employed for gathering the toners and impurities that have been scraped off. It should be noted that, since the toners are adhered to the photoconductor drum 100 by the potential distributed on the photoconductor drum 100, it is hard to completely remove the toner from the photoconductor drum 100 only using the brush 114. Thus, the blade 112 will scrape off the toners from the surface of the photoconductor drum 100 after the brush 114 brushes the surface. After the blade 112 scrapes off the impurities and toners from the surface of the photoconductor drum 100, as the toner transportation component 116 does not directly contact the photoconductor drum 100, the impurities and toners are taken into the toner transportation component 116 only when a certain amount are accumulated. Via a path (a groove located on the toner transportation component 116, not shown), the toners and impurities scraped off are taken into the gathering tank (not shown), and the cleansing step is finished. Consequently, the photoconductor drum 100 can keep a good image forming quality for a next image forming process.

The brush 114 and the toner transportation component 116 both need a dedicated driving apparatus, such as motors, so that the brush 114 can brush away impurities on the surface of the photoconductor drum 100 and the toner transportation component 116 can transport the impurities and toners to the gathering tank along the transportation path. However, in the conventional cleansing apparatus, there exist duplicate driving apparatus with similar functions for driving the brush 114 and the toner transportation component 116, which increases the hardware costs and occupies available space inside the laser printer. Moreover, in the conventional art, toners and impurities will not be taken into the transportation path of the toner transportation component 116 until toners and impurities are accumulated to a certain amount. That is, cleansing is not immediate, which can result in the fact that toners and impurities pollute the other components in the laser printer through air convection before being taken into the toner transportation component 116.

### SUMMARY OF THE INVENTION

It is therefore an object of the present invention to provide a cleansing apparatus combining a brush and a toner transportation component. Since the brush and the transportation component are disposed on a single shaft in the present invention, they can simultaneously be driven by a same driving apparatus to cleanse the photoconductor drum, thereby increasing the cleansing efficiency. Compared with the conventional design of the cleansing apparatus, the cleansing apparatus of the present invention decreases the hardware and firmware costs, and reduces the necessary of the space of the image forming apparatus.

Moreover, another advantage of combining the brush and the toner transportation unit is that the brush can help the toner transportation component gather and take toners and impurities scraped off by the blade into the gathering tank more effectively.

Thus, in accordance with a preferred embodiment of the cleansing apparatus of the present invention, a cleansing apparatus for cleansing a photoconductor drum is provided. The cleansing apparatus includes a blade, a gathering tank and a residual material transportation module. The blade is contacted with the photoconductor drum for scraping off residual materials adhered to a surface of the photoconductor drum. The gathering tank is for gathering the residual materials. The residual material transportation module includes a transportation component, a cleansing component and a transportation path. In addition, the transportation component is disposed at an upstream position of the blade in a rotating direction of the photoconductor drum. The cleansing component is disposed on the surface of the transportation component and in contact with the photoconductor drum, and utilized for cleansing the photoconductor drum. The transportation path is formed by the transportation component and the cleansing component, wherein the cleaning component brings the residual materials scraped off from the surface of the photoconductor drum into the transportation path and the transportation component transports the residual materials to the gathering tank.

In accordance with a preferred embodiment of the present invention, an image forming apparatus is provided. The image forming apparatus comprises: a photoconductor drum and a cleansing apparatus. The photoconductor drum rotates in a rotating direction for forming an image on a recording medium. The cleansing apparatus is for cleansing a surface of the photoconductor drum. The cleansing apparatus comprises: a blade, a gathering tank, and a residual material transportation module. The blade is contacted with the photoconductor drum for scraping off residual materials adhered to the surface of the photoconductor drum. The gathering tank is for gathering the residual materials. In addition, the residual material transportation module comprises: a transportation component, a cleansing component, and a transportation path. The transportation component is disposed at an upstream position of the blade in the rotating direction of the photoconductor drum. The cleansing component is disposed on the surface of the transportation component, in contact with the photoconductor drum, and for cleansing the photoconductor drum. The transportation path is formed by the transportation component and the cleansing component, wherein the cleaning component brings the residual materials scraped off from the surface of the photoconductor drum into the transportation path and the transportation component transports the residual materials to the gathering tank.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a conventional cleansing apparatus for cleaning a photoconductor drum.

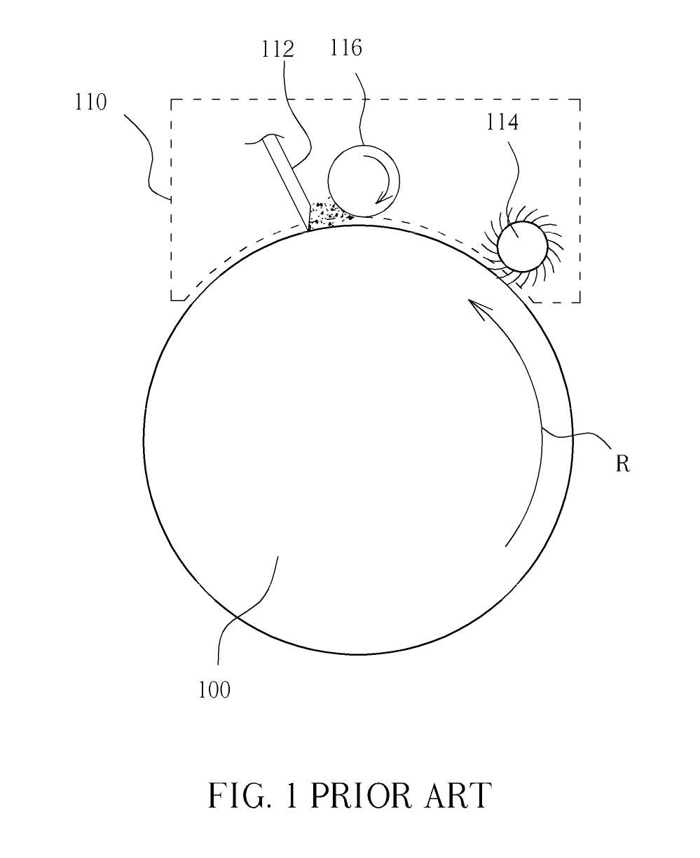

FIG. 2 is a diagram of a cleansing apparatus according to one preferred embodiment of the present invention.

FIG. 3 is a diagram of a cleansing apparatus according to another embodiment of the present invention.

FIG. 4 is a diagram of the residual material transportation module according to an embodiment of the present invention.

FIG. 5 is a diagram of the residual material transportation module according to another embodiment of the present invention.

FIG. 6 is a diagram of an image forming apparatus according to an embodiment of the present invention.

### DETAILED DESCRIPTION

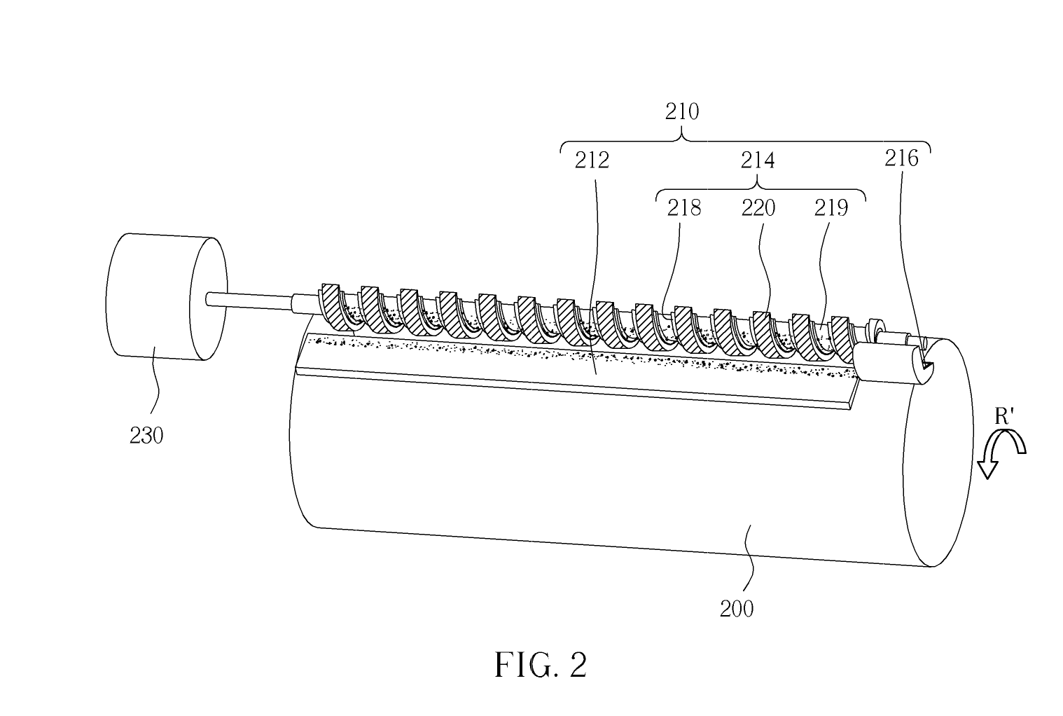

Please refer to FIG. 2, which shows a diagram of a cleansing apparatus according to one preferred embodiment of the present invention. As shown in FIG. 2, a cleansing apparatus 210 is for cleansing a photoconductor drum 200 by removing residual materials (e.g. impurities, toners, or dusts) from a surface of the photoconductor drum 200. In this embodiment, the cleansing apparatus 210 comprises a blade 212, a residual material transportation module 214, and a gathering tank 216. The blade 212 is contacted with the photoconductor drum 200 for scraping off the residual materials adhered to a surface of the photoconductor drum 200 so that the photoconductor drum 200 can be cleansed and therefore a next image forming operation can be performed. The gathering tank 216 is disposed at an end of the residual material transportation module 214 for gathering the residual materials scraped off from the surface of the photoconductor drum 200. In addition, the residual material transportation module 214 comprises: a transportation component 218, a transportation path 219 and a cleansing component 220. The transportation component 218 is disposed at an upstream position of the blade 212, in a rotating direction R′ of the photoconductor drum 200. The cleansing component 220, which can be implemented by a brush, is disposed on the surface of the transportation component 218. In this embodiment, the cleansing component 220 disposed spirally on the surface of the transportation component 218, contacting with the photoconductor drum 200. The cleansing component 220 is for cleansing the photoconductor drum 200. The transportation path 219 is formed by the transportation component 218 and the cleansing component 220. In this embodiment, the transportation path 219 is a spiral path and the cleaning component 220 brings the residual materials scraped off from the surface of the photoconductor drum 200 into the transportation path 219. Then, through a driving apparatus 230, the residual materials are transported by the transportation component 218 in the direction of the gathering tank 216 along the transportation path 219. Consequently, the residual materials are gathered by the gathering tank 216.

In this embodiment, there is no limitation in the movement of the driving apparatus 230; that is, the residual material transportation module 214 may rotate in the rotating direction R′ of the photoconductor drum 200 or rotate in a direction differed from the direction R′ of the photoconductor drum 200. Both these modifications fall within the scope of the present invention. It should be noted that, if the residual material transportation module 214 rotates in the direction differed from the rotating direction R′ of the photoconductor drum 200, the speed of surface movement of the residual material transportation module 214 has to be faster than that of the photoconductor drum 200 so that the residual materials scraped off from the photoconductor drum 200 by the blade 212 can be wholly brought into the transportation path 219 of the transportation component 218 and further be gathered in the gathering tank 216. However, if the residual material transportation module 214 rotates in the rotating direction R′ of the photoconductor drum 200, the speed of surface movement of the residual material transportation module 214 does not have to be faster than that of the photoconductor drum 200.

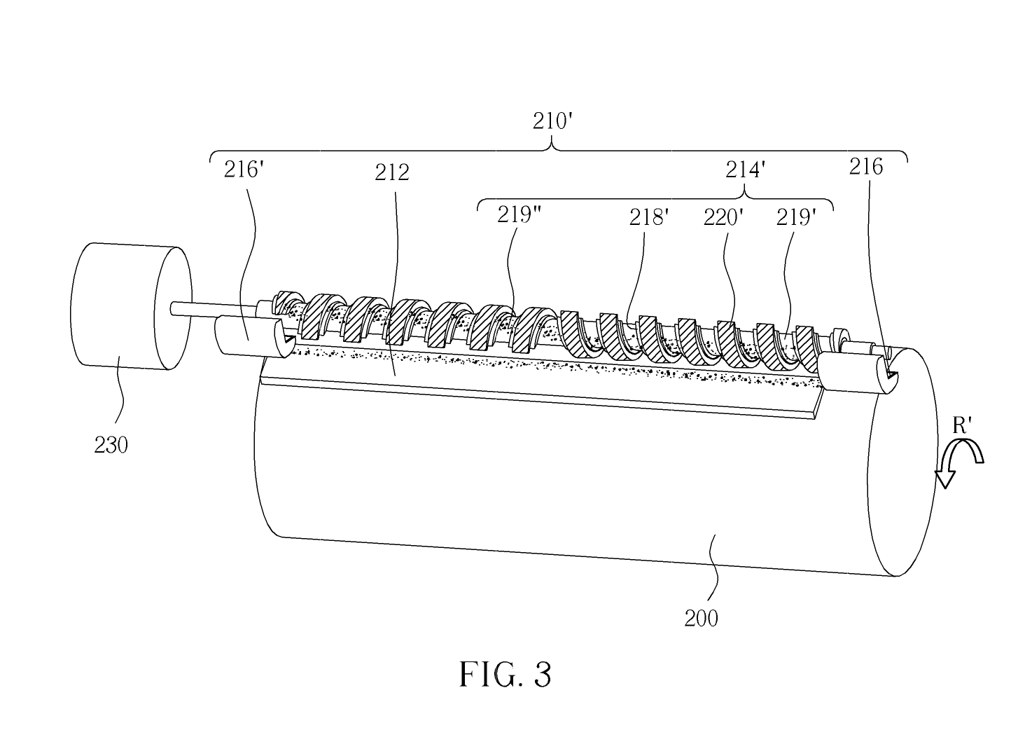

Please refer to FIG. 3, which is a diagram of the cleansing apparatus according to another embodiment of the present invention. Please note that components in FIG. 3 that are numbered identically to those in FIG. 2 have the same functions and operations, so further descriptions are omitted here. A cleansing apparatus 210′ includes two gathering tanks 216 and 216′, which are respectively disposed at two opposite ends of the residual material transportation module 214′ for gathering the residual materials scraped off from the surface of the photoconductor drum 200 by the blade 212. However, the transportation paths 219′ and 219″ which are formed by the transportation component 218′ and the cleansing component 220′ is a double-spirals path (which includes two spirals in different directions from the center point of the transportation module 214′). Thus, when the driving apparatus 230 drives the residual material transportation module 214′, the residual materials which are brought into the transportation paths 219′ and 219″ in different directions will be respectively transported to the gathering tanks 216 and 216′ according to the shorter transporting distance from the center point of the transportation module 214′ to the gathering tanks 216 and 216′ of the transportation paths 219′ and 219″. This embodiment can provide a faster residual material gathering mechanism, which increases the efficiency of the cleansing apparatus 210′.

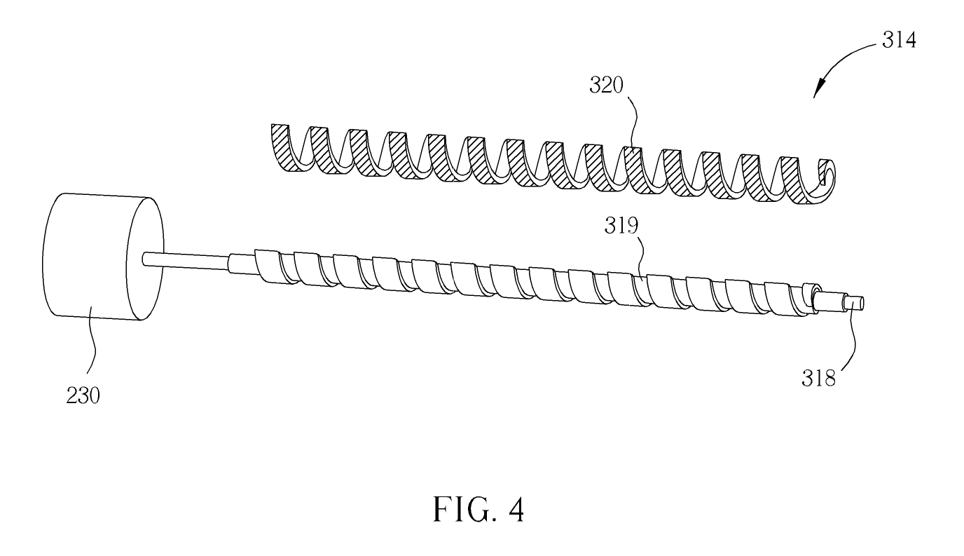

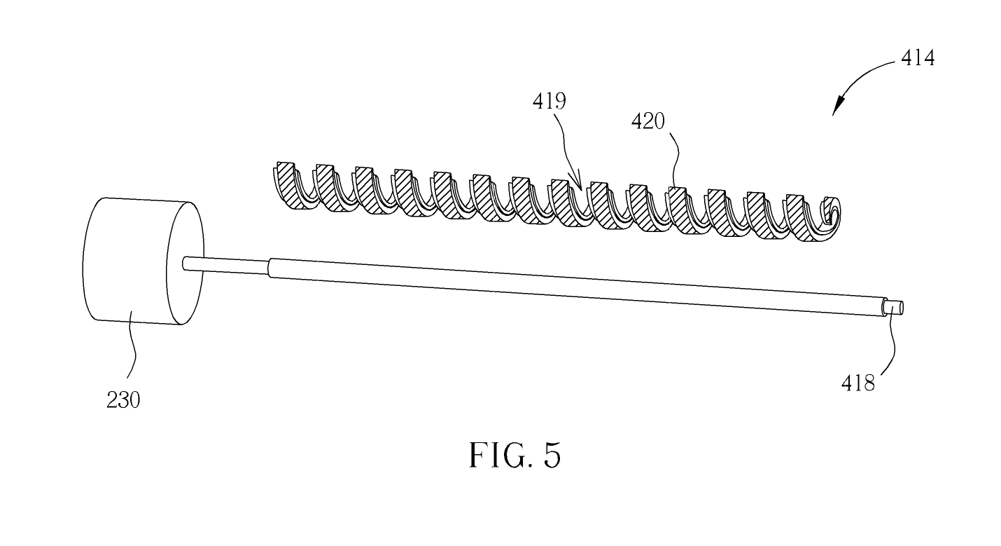

Please refer to FIG. 4, which depicts a detailed diagram of the residual material transportation module according to one embodiment of the present invention. As shown in FIG. 4, in the residual material transportation module 314, the cleansing component 320 is disposed spirally on the surface of the transportation component 318 for cleansing the photoconductor drum 200 and bringing the residual materials scraped off from the photoconductor drum 200 into the transportation path 319. Please refer to FIG. 5, which depicts a detailed diagram of the residual material transportation module according to one embodiment of the present invention. Compared to the embodiment shown in FIG. 4, a transportation component 418 does not have a spiral groove thereon; instead, a cleansing component 420 having a thicker base is used to form a spiral groove as the transportation path 419 on the transportation component 418. Through the embodiments shown in FIG. 4 and FIG. 5, it is expressly specified that the transportation path is a groove formed by the transportation component and cleansing component wherein the groove is not limited in terms of shape and structure. Furthermore, the transportation path being a spiral groove in the above-mentioned embodiments is just for illustrative purposes and is not meant to be a limitation. In other words, utilizing any transportation path in another shape should also fall within the scope of the present invention.

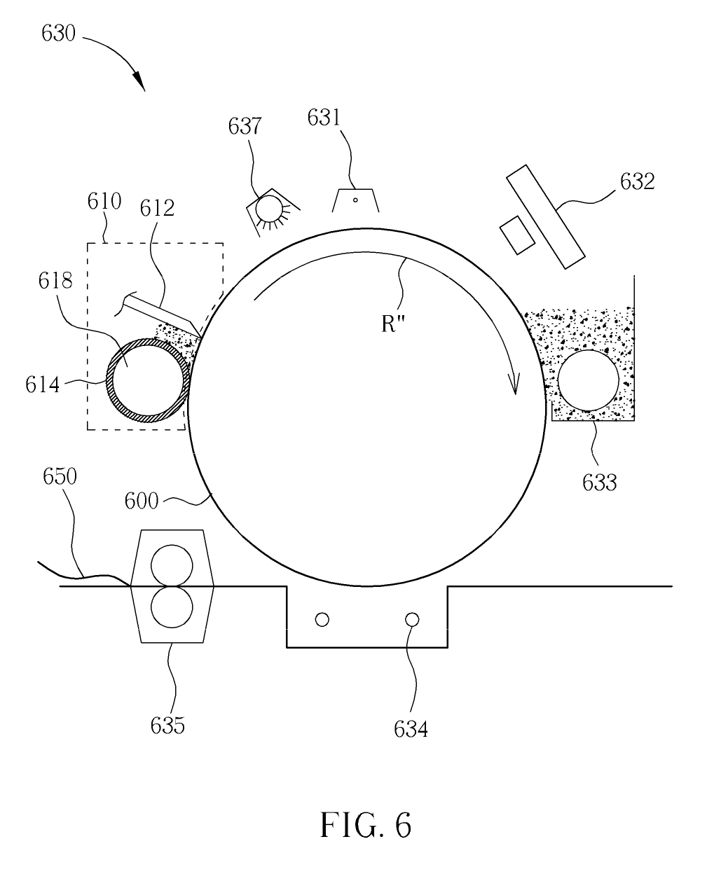

Please refer to FIG. 6, which depicts a structural diagram of an image forming apparatus utilizing the cleansing apparatus of the present invention. An image forming apparatus includes a photoconductor drum 600, a charging unit 631, an exposure unit 632, a developing unit 633, a transferring unit 634, a fusing unit 635, a cleansing apparatus 610 and an erasing unit 637. Wherein the cleansing apparatus 610 is the same as the present invention mentioned above.

When an image forming operation is performed, a photoconductor drum 600 rotates in a rotating direction R″. The charging unit 631 uniformly charges the surface of the photoconductor drum 600. With the rotation, the exposure unit 632 performs an exposing operation in response to an image information, for example, by means of a laser optical system to form an electrostatic latent image on the photoconductor drum 600, which makes the photoconductor drum 600 conductive. The developing unit 633, for example a developer cartridge, visualizes the electrostatic latent image by applying magnetic toner to adhere on the surface of the photoconductor drum 600 in accordance with the electrostatic latent image, then a latent image is formed on the surface of the photoconductor drum 600 by the developed toner. Then, the transferring unit 634 applies a high positive voltage on a recording medium 650 to make the recording medium 650 positively charged, which further attracts the magnetic toner transferred onto the recording medium 650 due to the electrical field force. Finally, the fusing unit 635 fuses the magnetic toner on the recording medium 650, forming the image on the recording medium 650. Accordingly, the cleansing apparatus 610 is used to cleanse the surface of the photoconductor drum 600 mentioned above. The cleansing apparatus 610 comprises a blade 612 and a residual material transportation module 614. The blade 612 is contacted with the photoconductor drum 600 and is for scraping off residual materials from the surface of the photoconductor drum 600. The residual material transportation module 614 transports these residual materials into a gathering tank (not shown). Since the detailed functions and structures of the cleansing apparatus 610 are similar to those of the cleansing apparatus 210 shown in FIG. 2, further descriptions are omitted here for the sake of brevity. Finally, the erasing unit 637 discharges residual electric charge on the surface of the photoconductor drum 600.

Although the relative position between the blade 612 and the residual material transportation module 614 in the cleansing apparatus 610 is different from that in the cleansing apparatus 210 disclosed in FIG. 2, the transportation component 618 is still positioned at an upstream position of the blade 612 in the rotation direction R″ of the photoconductor drum 600 so that the residual material transportation module 614 can successfully gather the scraped residual materials.

The cleansing component and the transportation component are disposed at a same driving apparatus and the order of the operations are properly arranged in the present invention, thereby providing a cleansing apparatus of lower cost and greater cleansing effect than the conventional cleansing apparatus.

Those skilled in the art will readily observe that numerous modifications and alterations of the device and method may be made while retaining the teachings of the invention.

What is claimed is:

1. A cleansing apparatus for cleansing a photoconductor drum, comprising:
a blade, contacted with the photoconductor drum, for scraping off residual materials adhered to a surface of the photoconductor drum;
a gathering tank, for gathering the residual materials; and
a residual material transportation module, comprising:
a transportation component, disposed at an upstream position of the blade in a rotating direction of the photoconductor drum;
a cleansing component, disposed on the surface of the transportation component and in contact with the photoconductor drum, for cleansing the photoconductor drum; and
a transportation path, formed by the transportation component and the cleansing component, wherein the cleaning component brings the residual materials scraped off from the surface of the photoconductor drum into the transportation path and the transportation component transports the residual materials to the gathering tank.

2. The cleansing apparatus of claim 1, wherein the residual material transportation module is coupled to a driver which drives the residual material transportation module to rotate.

3. The cleansing apparatus of claim 2, wherein the residual material transportation module rotates in the rotating direction of the photoconductor drum.

4. The cleansing apparatus of claim 2, wherein the residual material transportation module rotates in a direction differed from the rotating direction of the photoconductor drum.

5. The cleansing apparatus of claim 1, wherein the gathering tank is disposed at an end of the residual material transportation module.

6. The cleansing apparatus of claim 1, wherein the transportation path is a spiral path.

7. The cleansing apparatus of claim 1, wherein the cleansing component is disposed spirally on the transportation component.

8. The cleansing apparatus of claim 1, wherein the cleansing component is a brush.

9. An image forming apparatus, for performing an image forming operation, comprising:
a photoconductor drum, rotating in a rotating direction, for forming an image upon a recording medium; and
a cleansing apparatus, for cleansing a surface of the photoconductor drum, comprising:
a blade, contacted to the photoconductor drum, for scraping off residual materials adhered to the surface of the photoconductor drum;
a gathering tank, for gathering the residual materials; and
a residual material transportation module, comprising:
a transportation component, disposed at an upstream position of the blade in the rotating direction of the photoconductor drum;
a cleansing component, disposed on the surface of the transportation component and in contact with the photoconductor drum, for cleansing the photoconductor drum; and
a transportation path, formed by the transportation component and the cleansing component, wherein the cleaning component brings the residual materials scraped off from the surface of the photoconductor drum into the transportation path and the transportation component transports the residual materials to the gathering tank.

10. The image forming apparatus of claim 9, wherein the residual material transportation module is coupled to a driver which is utilized for driving the residual material transportation module to rotate.

11. The image forming apparatus of claim 10, wherein the residual material transportation module rotates in the rotating direction of the photoconductor drum.

12. The image forming apparatus of claim 10, wherein the residual material transportation module rotates in a direction differed from the rotating direction of the photoconductor drum.

13. The image forming apparatus of claim 9, wherein the gathering tank is disposed at an end of the residual material transportation module.

14. The image forming apparatus of claim 9, wherein the transportation path is a spiral path.

15. The image forming apparatus of claim 9, wherein the cleansing component is disposed spirally on the transportation component.

16. The image forming apparatus of claim 9, wherein the cleansing component is a brush.
